(19) United States
(12) Patent Application Publication
(10) Pub. No.: US 2011/0106656 A1
(43) Pub. Date: May 5, 2011

(54) IMAGE-BASED SEARCHING APPARATUS AND METHOD

(75) Inventor: David Schieffelin, New York, NY (US)

(73) Assignee: 24eight LLC, New York, NY (US)

(21) Appl. No.: 12/515,146

(22) PCT Filed: Nov. 15, 2007
(86) PCT No.: PCT/US07/23959

§ 371 Date: Dec. 8, 2010

Related U.S. Application Data
(60) Provisional application No. 60/858,954, filed on Nov. 15, 2006.

(51) Int. Cl. G06Q 30/00; G06K 9/68; G06K 9/00

(52) U.S. Cl. 705/26.9; 382/218; 382/170

(57) ABSTRACT

Disclosed is a system and method in which an image is detected and matched with an image stored in a database, the method comprising capturing an image or series of images; searching a database that has a plurality of stored images for comparison with the captured image matching the captured image to the stored images; locating stores, manufacturers, or distributors that sell, make or distribute the object or those objects that are similar to the matched object; and presenting colors that are available to the user or asking what color the user wants, pricing, available colors, and other pertinent information regarding the matched object.

### FIELD OF INVENTION

The disclosed system is directed to an image processing system, in particular, object segmentation, object identification, retrieval of purchase information regarding the identified object.

### SUMMARY

Disclosed is a system and method in which an image is detected and matched with an image stored in a database, the method comprising capturing an image or series of images; searching a database storing a plurality of images for comparison with the captured image matching the captured image to the stored images; locating vendors (e.g., stores and on-line retailers), manufacturers, or distributors that sell, make or distribute the object or those objects that are similar to the matched object; and presenting colors that are available to the user or asking what color the user wants, pricing, and other pertinent information regarding the matched object.

### BRIEF DESCRIPTION OF THE FIGURES

Exemplary embodiments will be described with reference to the attached drawing figures, wherein:

FIG. 1 illustrates an exemplary embodiment of a system implementation of the exemplary method.

### DETAILED DESCRIPTION

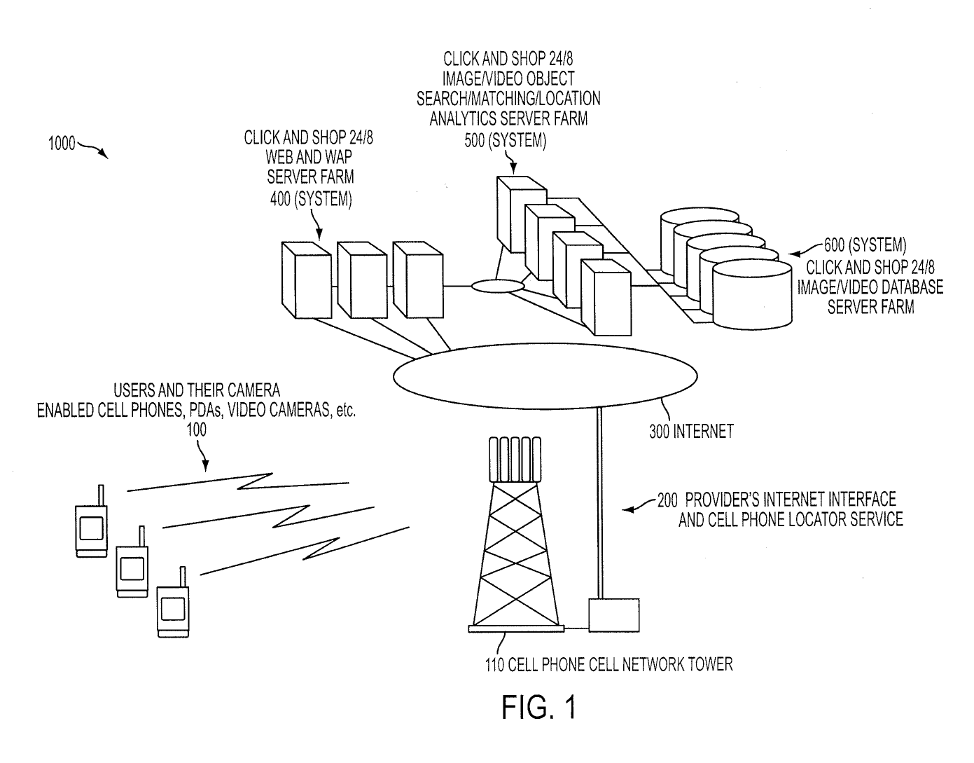

FIG. 1 illustrates an exemplary embodiment of a system for implementing the exemplary method that will be described in more detail below. The exemplary system 1000 comprises camera-enabled communication devices, e.g., cellular telephones and Personal Digital Assistants 100. Images (video clips or still) obtained on the camera-enabled communication devices 100 are sent over the communication network 110 to a provider's Internet interface and cell phone locator service 200. The provider's Internet interface and cell phone locator service 200 connects with the Internet 300. The Internet 300 connects with the system web and WAP server farm 400 and delivers the image data obtained by the camera-enabled cellular telephone 100. The image data is analyzed according to exemplary embodiments of the method on the search/matching/location analytics server farm 500. Analytics server farm 500 processes the image and other data (e.g., location information of user), and searches image/video databases on the image/video database server farm 600. Information returned to the user cellular telephone or PDA 100 includes, for example, model, brand, price, availability and points of sale or purchase with respect to the user's location or a location specified by the user. Of course, more or less information can be provided and on-line retailers can be included.

The disclosed method implements algorithms, processes, and techniques for video image and video clip retrieval, clustering, classification and summarization of images. A hierarchical framework is implemented that is based on the bipartite graph matching algorithms for the similarity filtering and ranking of images and video clips. A video clip is a series of frames with continuous video (cellular, etc.) camera motion. The video image and video clip will be used for the detection and identification of existing material objects. Usage of query-by-video clip can result in more concise and convenient detection and identification than query-by-video image (e.g. single frame).

The query-by-video clip method incorporates image object identification techniques that use several algorithms one of which uses a neural network. Of course, the exemplary video clip query works with different amounts of video image data (including single frame). An exemplary implementation of the neural network uses similarity ranking of image videos and video clips that derive signatures to represent the video image/clip content. The signatures are summaries or global statistics of low-level features in the video image/clips. The similarity of video image/clips depends on the distance between signatures. The global signatures are suitable for matching video image/clips with almost identical content but little changes due to compression, formatting, and minor editing or differences in spatial or temporal domain.

The video clip-based (e.g., sequence of images collected at 10-20 frames per second) retrieval is built on the video image-based retrieval (e.g., single frame). Besides relying on video image similarity, video clip similarity is also dependent on the inter-relationship such as the temporal order, granularity and interference among video images and the like. Video images in two video clips are matched by preserving their temporal order. Besides temporal ordering, granularity and interference are also taken into account.

Granularity models the degree of one-to-one video image matching between two video clips, while the interference models the percentage of unmatched video images. A cluster-based algorithm can be used to match similar video images.

The aim of the clustering algorithm is to find a cut or threshold that can maximize the center vector based distances of similar and dissimilar video images. The cut value is used to decide whether two video images should be matched. The method can also use a threshold value that is predefined to determine the matching of video images. Two measures, re-sequence and correspondence, are used to assess the similarity of video clips. The correspondence measure partially evaluates the degree of granularity. Irrelevant video clips can be filtered prior to similarity ranking. Re-sequencing is the capability to skip low quality images (e.g., noisy images), and move to a successive image in the sequence to search for an image of acceptable quality to perform segmentation.

The video image and video clip matching algorithm is based on the correspondence of image segmented regions. The video image regions are extracted using segmentation techniques such as a weighted video image aggregation algorithm. In a weighted video image aggregation algorithm, the video image regions are represented by constructing hierarchical graphs of video image aggregates from the input video images. These video image aggregates represent either pronounced video image segments or sub-segments of the video image. The graphs are then trimmed to eliminate the very small video image aggregates. The matching algorithm finds, and matches rough sub-tree isomorphism graphs between the input video image and archived video images. The isomorphism is rough in the sense that certain deviations are allowed between the isomorphic structures. This rough sub-graph isomorphism leverages the hierarchical structure between input video image and the archived video images to constrain the possible matches. The result of this algorithm is a correspondence between pairs of video image aggregate regions.

Video image segmentation can be a two-phase process. Discontinuity or the similarity between two consecutive frames is measured followed by a neural network classifier stage to detect the transition between frames based on a decision strategy which is the underlying detection scheme. Alternatively, the neural network classifier can be tuned to detect different categories of objects, such as automobiles, clothing, shoes, household products and the like. The video image segmentation algorithm supports both pixel-based and feature-based processing. The pixel-based technique uses inter-frame difference (ID), in which the inter-frame difference is counted in terms of pixels as the discontinuity measure. The inter-frame difference is preferably a count of all the pixels that changed between two successive video image frames in the sequence. The ID is preferably the sum of the absolute difference, in intensity values, for example, of all the pixels between two successive video image frames, for example, in a sequence. The successive video image frames can be consecutive video image frames. The pixel-based inter-frame difference process breaks the video images into regions and compares the statistical measures of the pixels in the respective regions. Since fades are produced by linear scaling of the pixel intensities over time, this approach is well suited to detect fades in video images. The decision regarding presence of a break can be based on an appropriate selection of the threshold value.

The feature-based technique is based on global or local representation of the video image frames. The exemplary method can use histogram techniques for video image segmentation. This histogram is created for the current video image frame by calculating the number of times each of the discrete pixel value appears in the video image frame. A histogram-based technique that can be used in the exemplary method extracts and normalizes a vector equal in size to the number of levels the video image is coded in. The vector is compared with or matched against other vectors of similar video images in the sequence to confirm a certain minimum degree of dissimilarity. If such a criterion is successfully met, the corresponding video image is labeled as a break and then a normalized histogram is calculated.

Various methods for browsing and indexing into video image sequences are used to build content based descriptions. The video image archive will represent target class sets of objects as pictorial structures, whose elements are neural network learnable using separate classifiers. In that framework, the posterior likelihood of there being a video image object with specific parts at particular video image location would be the product of the data likely-hoods and prior likely-hoods. The data likely-hoods are the classification probabilities for the observed sub-video images at the given video image locations to be video images of the required sub-video images. The prior likely-hoods are the probabilities for a coherent video image object to generate a video image with the given relative geometric position points between each sub-video image and its parent in the video image object tree.

Video image object models can represent video image shapes. Video image object models are created from the video image initialized input. These video image object models can be used to recognize video image objects under variable illumination and pose conditions, for example, entry points for retrieval and browsing, video image signatures, are created based on the detection of recurring spatial arrangements of local features. These features are represented as indexes for video image object recognition, video image retrieval and video image classification. The method uses a likely-hood ratio for comparing two video image frame regions to minimize the number of missed detections and the number of incorrect classifications. The frames are divided into smaller video image regions and these regions are then compared using statistical measures.

The method supports bipartite graph matching algorithms that implement maximum matching (MM) and optimal matching (OM), for the matching of video images in video clips. MM is capable of rapidly filtering irrelevant video clips by computing the maximum cardinality of matching. OM is able to rank relevant clips based on the similarity of visual and granularity by optimizing the total weight of matching. MM and OM can thus form a hierarchical framework for filtering and retrieval. The video clip similarity is jointly determined by visual, granularity, order and interference factors.

The method implements a bipartite graph algorithm to create a bipartite graph supporting many-to-many image data points mapping as a result of a query. The mapping results in some video images in the video clip are densely matched along the temporal dimension, while most video images are sparsely matched or unmatched. The bipartite graph algorithm will automatically locate the dense regions as potential candidate video images. The similarity is mainly based on maximum matching (MM) and optimal matching (OM). Both MM and OM are classical matching algorithms in graph theory. MM computes the maximum cardinality matching in an un-weighted bipartite graph, while OM optimizes the maximum weight matching in a weighted bipartite graph. OM is capable of ranking the similarity of video clips according to the visual and granularity factors. Based on MM and OM, a hierarchical video image retrieval framework is constructed for the matching of video clips. To allow the matching between a query and a long video clip, a video clip segmentation algorithm is used to rapidly locate candidate video clips for similarity measure. Of course, still imagery in digital form can also be analyzed using the algorithms described above.

An exemplary system includes several components, or combinations thereof, for object image/video acquisition, analysis, matching for determining information regarding items detected in an image or video clip, for example, the price, available colors, distributors and the like, and for providing object purchase location (using techniques, such as cellular triangulation systems, MPLS, or GPS location and direction finder information from a user's immediate location or other user-specified locations), and other key information for an unlimited amount of object images and object video clips. The acquired object images and object video clips content are processed by a collection of algorithms, the results of which can be stored in a large distributed image/video database. Of course, the acquired image/video data can be stored in another type of storage device. New object images and object video clips content are added to the object images and object video clips database by a site for its constituents or system subscribers.

The back-end system is based on a distributed computing clustered-based architecture that is highly scalable, and can be accessed using standard cellular phone technology, PDA prevailing technology (including but not limited to iPod, Zune, or other hand-held devices), and/or digital video or still camera image data or other source of digital image data. From a client perspective, the system can support simple browser interfaces through to complex interfaces such as the asynchronous javascript and XML (AJAX) Web 2.0 specification.

The object images and object video clips content-based retrieval process of the system allows very efficient image and video search/retrieval. The process can be based on video signatures that have been extracted from the individual object images and object video clips for a particular stored image/video object. Specifically, object video clips are segmented at the image video level by extracting the frames using a cut-detection algorithm, and processed as still object images. Next, from each of these image videos, a representative of the content within each video image is chosen. Visual features based on the color characteristics of selected key-frames are extracted from the representative content. The sequence of these features forms a video signature, which compactly represents the essential visual information of the object image (e.g., single frame) and/or objects video clip.

The system creates a cache based on the extracted signatures of object images and objects video clips from the image/video database. The database stores data that represents stored objects that can be searched for with their locations for purchase and any other pertinent information, such as price, inventory, availability, color availability, and size availability. This will allow for, as an example, extremely fast object purchase location data acquisition.

The system search algorithms can be based on color histograms which compares similarity with the color histogram in the image/video, by illumination invariance which compares the similarity with color chromaticity in the normalized image/video, by color percentage which allows for the specification of color and percentages in the image/video, by color layout which allows for specification of the layout of colors with various grid sizes in the image/video, by edge density and orientation in the image/video, by edge layout with the capability of specifying edge density and orientation in various grid size in the image/video, and/or object model type class specification of an object model type class in the image/video, or any combination of search and comparison methods.

Examples of uses include:

Mobile/Cellular PDA—Shopping

A user is sitting at a restaurant and likes someone's shoes. The user click a photograph of the shoes using a cellular telephone camera, for example. The photograph data is delivered (e.g., transmitted) to an Internet website or network, such as Shop 24/8. The website returns to the user information that tells the user the make, the brand (or comparable), price, color, size and where to find the shoe. It will also determine based on GPS or similar location determination techniques, the closest point-of-sale location and directions to that point-of-sale location from where the user is located.

Web Based—Shop

A friend sends a user a picture of her vacation. The user likes the friend's shirt, so the user crops the shirt from the image, and drags it to a user interface with an Internet website or similar network. The search engine at the Internet website finds the shirt (or comparable), price, color, size and where to find the shirt. It will also determine based on GPS or similar location determination techniques, the closest point-of-sale location and directions to that point-of-sale location from where the user is located.

Video—Shop

A user is watching a video and likes a product in the video. The user captures isolates or selects the product from the video. The user can crop to the product and drags it to a user interface with an Internet website or similar network. The search engine at the Internet website finds the product (or comparable), price, color, size and where to find the shirt. It will also determine based on GPS or similar location determination techniques, the closest point-of-sale location and directions to that point-of-sale location from where the user is located.

It would be appreciated by those skilled in the art that the present invention can be embodied in other specific forms without departing from the spirit or essential characteristics thereof. The presently disclosed embodiments are there for considered and all respect to be illustrative. The scope of the invention is indicated by the appended claims rather than the foregoing description and all changes that come within the meaning and range and equivalence thereof are intended to be embraced therein.

1. A method of locating an object detecting in an image and directing a user to where the object can be purchased, the method comprising:
capturing an image or series of images;
searching a database that has a plurality of images stored for comparison with the captured image;
matching the captured image to a stored image;
locating stores or manufacturers or distributors that sell, make or distribute the object or those that are similar; and
presenting to the user pricing information, available colors, available sizes, location where items can be purchased, directions to the locations where items can be purchases, and/or requesting further information from the user.

2. The method of claim 1, wherein matching the images comprises:
determining a signature for each of the plurality of images stored and the captured image; and
comparing the signatures to determine a match.

3. The method of claim 2, further comprising creating a cache of signatures for the plurality of images stored.

4. The method of claim 3, wherein creating the cache comprises:
segmented at the image video level by extracting frames from the image using a cut-detection algorithm, and processed as still object images; selecting a representative of content within each;
extracting visual features of the frames from the representative content to form the signature.

5. The method of claim 1, further comprising:
constructing hierarchical graphs of image aggregates from the captured image; and
matching sub-tree isomorphism graphs between the captured image and the plurality of images stored to determine a correspondence between pairs of image aggregate regions.

6. The method of claim 5, further comprising:
measuring a discontinuity or similarity between two consecutive frames in the image; and
detecting a transition between the frames based on a decision strategy.

7. The method of claim 6, further comprising:
creating a histogram for the captured images by calculating a number of times each of a discrete pixel value appears in the respective frame;
extracting and normalizing a vector equal in size to a number of levels the image is coded in;
comparing the vector with other vectors of similar video images in s sequence to confirm a certain minimum degree of dissimilarity; and
corresponding video image is labeled as a break
calculating a normalized histogram.

8. The method of claim 5, wherein the discontinuity is determined based on an inter-frame difference which is a count of all pixels that changed between the two consecutive frames in the image.

9. The method of claim 8, wherein determining the count comprises:
breaking the image into regions; and
comparing a statistical measures of the pixels in respective regions; and
determining a break based on a threshold value.
